(19) United States
(12) Patent Application Publication
(10) Pub. No.: US 2006/0066583 A1
(43) Pub. Date: Mar. 30, 2006

(54) Text entry method and system using a numeric or non-QWERTY keypad

(76) Inventors: Michael Joseph Toutonghi, Bellevue, WA (US); Stephen Joseph Toutonghi, Seattle, WA (US); Jaroslav Bengl, Praha (CZ)

Correspondence Address: Hahn and Moodley LLP, Suite 180, 800 W El Camino Real, Mountain View, CA, 94040, US

(21) Appl. No.: 10/952,008

(22) Filed: Sep. 27, 2004

(51) Int. Cl. G09G 5/00

(52) U.S. Cl. 345/173

(57) ABSTRACT

In one embodiment, a method of precise text entry using a numeric keypad comprising numeric keys and non-numeric keys is provided. The method comprises mapping each of a plurality of pairs of keys to an associated character value, each key in a pair being selected from the group consisting of the numeric keys and the non-numeric keys, wherein the numeric keys range from 0 to 9; and selecting the character value mapped to a user-input pair of keys as a return character value.

### FIELD OF THE INVENTION

Embodiments of the invention relate to a method and apparatus for entering text using a numeric or non-QWERTY keypad.

### BACKGROUND

Today many consumer devices exist that have a numeric or non-QWERTY keypad for data entry. Examples of such consumer devices include television remote controls, mobile telephones, personal digital assistants (PDAs), etc. A numeric keypad may include numeric keys corresponding to the numbers 0 to 9, as well as non-numeric keys such as the “*” and “#” keys. Typically, each numeric key in the numeric keypad can be used in a text entry mode to input three and sometimes even four letters. Since a single key is mapped to many letters, inputting the correct letter often requires several key presses, is prone to error, and is time consuming.

### BRIEF DESCRIPTION OF THE DRAWINGS

FIG. 1 shows a high-level functional block diagram of apparatus in accordance with one embodiment of the invention;

FIG. 2 shows an example of a keypad forming part of the apparatus of FIG. 1;

FIG. 3 shows a functional block diagram of a text entry module forming part of the apparatus of FIG. 1;

FIGS. 4 and 5 show sample mappings in accordance with one embodiment of the inventions;

FIG. 6 shows a state diagram for the apparatus of FIG. 1;

FIG. 7 shows a flowchart of operations performed by the apparatus of FIG. 1 while in an idle state;

FIG. 8 shows a flowchart of operations performed by the apparatus of FIG. 1 while in a word entry state;

FIG. 9 shows a layout or structure of a map generated in accordance with one embodiment of the invention; and

FIGS. 10A-10C show examples of maps generated in accordance with one embodiments of the invention.

### DETAILED DESCRIPTION

The present disclosure describes a method of precise text entry using a numeric keypad. In the method, all characters in a character set can be input using a maximum of two key presses. A first of the two key presses selects or activates a map which may be displayed to a user. The map includes character values mapped to keys of the numeric keypad. The second of the key presses allows the user to select a character value in the map by pressing the key to which the character value is mapped. The selected character value is then chosen as a return character value. Advantageously, the character values in the map may be an uppercase letter, a lowercase letter, character string such as a predicted word that the user is likely to enter, or a predefined word. Determination of the predicted character string is based on the character values the user has precisely entered and the user's choice of a map as indicated by the first key press selecting the map.

In one embodiment, the character values in the map are mapped to keys of the numeric keypad in a manner that requires minimum lateral movement of a user's finger across the keypad to select a key corresponding to a character value.

Selection of a map constrains the choices for a possible current return character value corresponding to the current letter being input to the character values in the selected map. Thus, the problem of determining the predicted character string is constrained to words that have a character from the selected map in the position of the current letter of the word being input, in addition to an exact match of all the precisely entered characters of the character string up to the current letter. Given the above constraints, the accuracy of the predicted word is increased. Other advantages of the invention will be apparent from the description below.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

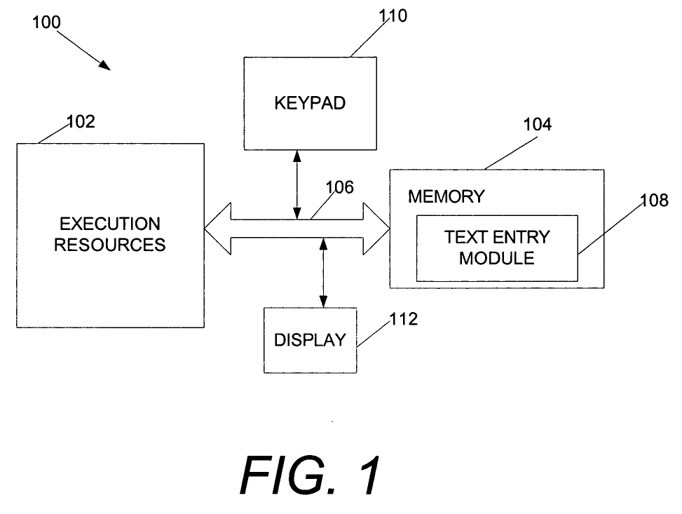

Turning now to FIG. 1 of the drawings, there is shown an apparatus 100 in accordance with one embodiment of the invention.

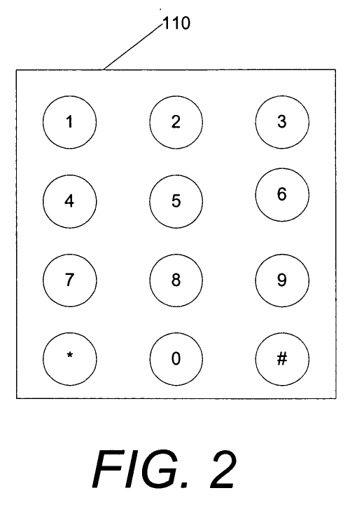

The apparatus 100 includes execution resources 102 to process instructions. For example, in one embodiment the execution resources 102 may comprise a central processing unit (CPU) or processor. The execution resources 102 are coupled to a memory 106 by a communications path 106. In one embodiment, the communications path may be in the form of a bus designed to carry instructions and data between the execution resources 102 and the memory 106. The memory 104 may be architected in accordance with any existing memory technology and includes a text entry module 108. A functional description of the blocks that comprise the text entry module 108, in accordance with one embodiment of the invention, is provided in FIG. 2 of the drawings.

The apparatus 100 also includes a keypad 110 that defines an input device for inputting characters of a character set into the apparatus 100. The keypad 110 is a numeric or a non-QWERTY keypad. In one embodiment, the apparatus 100 may also include a display 112.

Given the above described components it will be appreciated that the apparatus 100 may represent various consumer electronic devices such as a television remote control, a mobile telephone, a personal digital assistant (PDA), etc. It will be appreciated that for some devices, the memory 104 may not actually reside within the device, but may be part of another device such as a television. In this case the device communicates with the memory 104 remotely eg. through an infrared port.

FIG. 2 of the drawings show an embodiment of the numeric keypad 110. Although the text entry module 108 is shown to be part of the memory 104 in FIG. 1 of the drawings, it is to be understood that the text entry module 108 may, in some embodiments, be defined in firmware located within the execution resources 102.

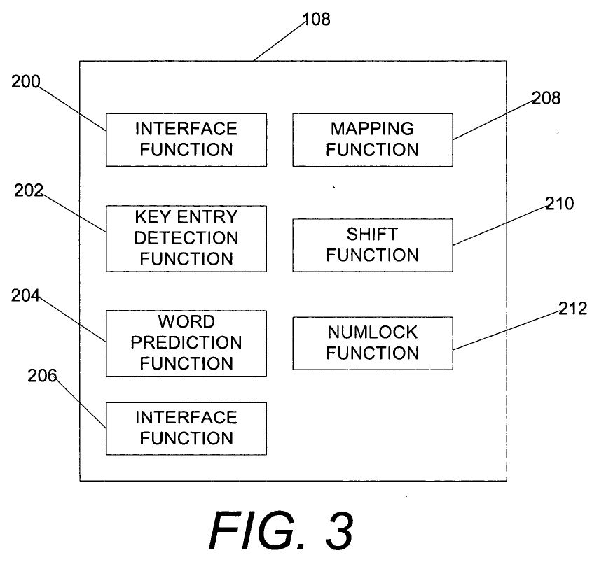

Turning now to FIG. 3 of the drawings, there is shown a functional block diagram of the components within the text entry module 108. As will be seen, the text entry module 108 includes an interface function 200, a key entry detection function 202, a prediction function 204, a dictionary generation function 206, a mapping function 208, a shift function 210, and a numlock function 212. A description of each of the functions is now provided:

The interface function 200:

This function generates a user-interface. In one embodiment, the user-interface includes a map which is displayed to a user in order to facilitate the precise entry of character values, as will be described in greater detailed below.

The key entry detection function 202:

This function includes logic to detect what key of the numeric keypad 110, the user has pressed.

The prediction function 204:

This function predicts a character string that the user is likely to input, as will be described in greater detail below.

The dictionary generation function 206:

This function generates a dictionary of frequently used words to be used by the word prediction function 204.

The mapping function 208:

This function generates a plurality of maps comprising character values mapped to particular keys of the numeric keypad 110, as will be described in greater detail below.

The shift function 210:

This function is an optional function that allows a user to shift through the maps generated by the mapping function 208, as will be explained in greater detail below.

The numlock function 212:

This function, when activated, causes the numeric keypad 110 to be locked in a “number mode” so that further key presses are interpreted as numbers from a number string, rather than particular selections within a map, as will be explained in greater detail below.

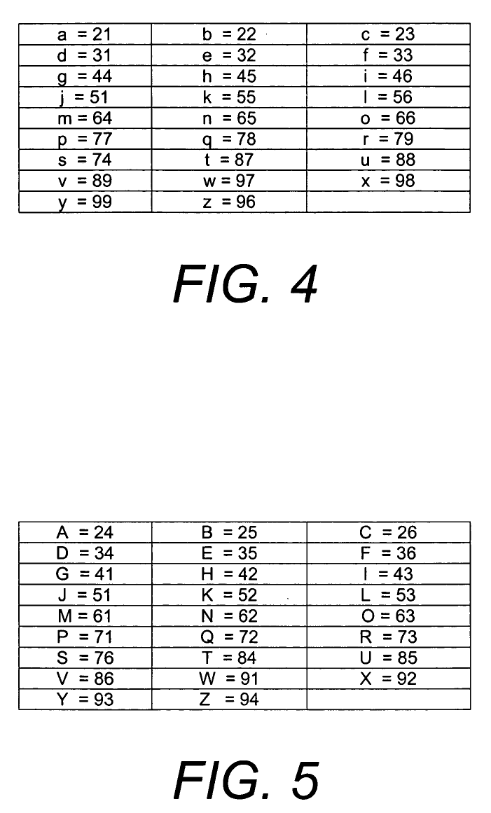

The mapping function 208 maps the characters of a character set to particular two-key combinations. The character set may be any character set, although for the purposes of descriptive convenience, the English alphabet set will be used. To understand the operation of the mapping function 208 consider the sample mappings shown in FIGS. 4 and 5 of the drawings. Referring to FIG. 4, this drawing shows the mapping of the lowercase letters of the English alphabet to particular two-key combinations. FIG. 5 shows the mappings of the uppercase letters of the English alphabet to particular two-key combinations. Given the mappings of FIGS. 4 and 5, it will be seen that a user may enter a character value “j” by inputting the two-key combination comprising the keys “5” and “1”. It is to be understood that by pressing the “5” key followed by the “1” key, the user is selecting the character value “j” precisely. That is to say the apparatus 100 is not predicting the return character value given the users input since the input is precise. Note, as used herein the term “return character value” is a reference to a particular character value output or selected by the apparatus 100 in response to a users input. Thus, in one sense the maps shown in FIGS. 4 and 5 of the drawings map particular character return values to particular two-key sequences or pairs. For example, given an input of “2” following by an input of “4”, the return character value selected by the apparatus 100 will be the character “A”, whereas if a user inputs an “8” followed by a “7” then the apparatus 100 will select the character “t” as the return character value.

The mappings shown in FIGS. 4 and 5 of the drawings is not arbitrary. Instead the mappings have been carefully selected to minimize the lateral displacement of a user's finger across the numeric keypad 110, as will be apparent from the description below.

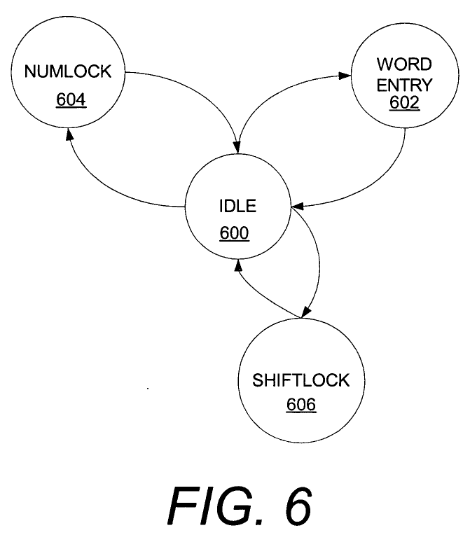

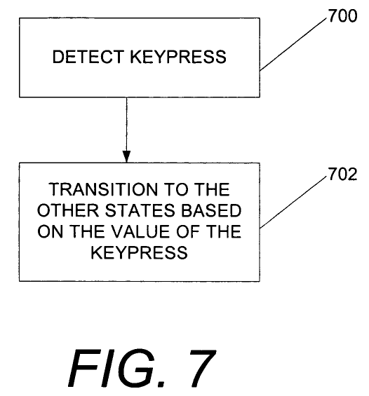

Turning now to FIG. 6 of the drawings, there is shown a state diagram for the text entry module 108. As will be seen, the text entry module includes an idle state 600, a word entry state 602, a numlock state 604, and a shift lock state 606. In one embodiment, the idle state 600 may be a default state and the module 108 transitions to the word entry state 602 when a user presses or selects one of the keys of the numeric keypad 110 and the selected key (hereinafter “key press”) is not a “numlock” key. A “numlock” key is a special key, for example the “#” key, which when selected by the user causes the module 108 to transition from the idle state 600 to the numlock state 604, as indicated in the state diagram of FIG. 6. In other words, in one embodiment, selection of the numeric keys 0 to 9 moves the module 108 from the idle state 600 to the word entry state 602, whereas selection of the “#” key moves the module 108 from the idle state 600 to the numlock state 604. The operations performed by the text entry module 108 while in the idle state 600 are conveniently summarized in FIG. 7 of the drawings. Referring to FIG. 7, it will be seen that at block 700 the module 108 detects a key press. At block 702, the text entry module 108 transitions to one of the other states in the state diagram of FIG. 6, based on the value of the key press, as described above.

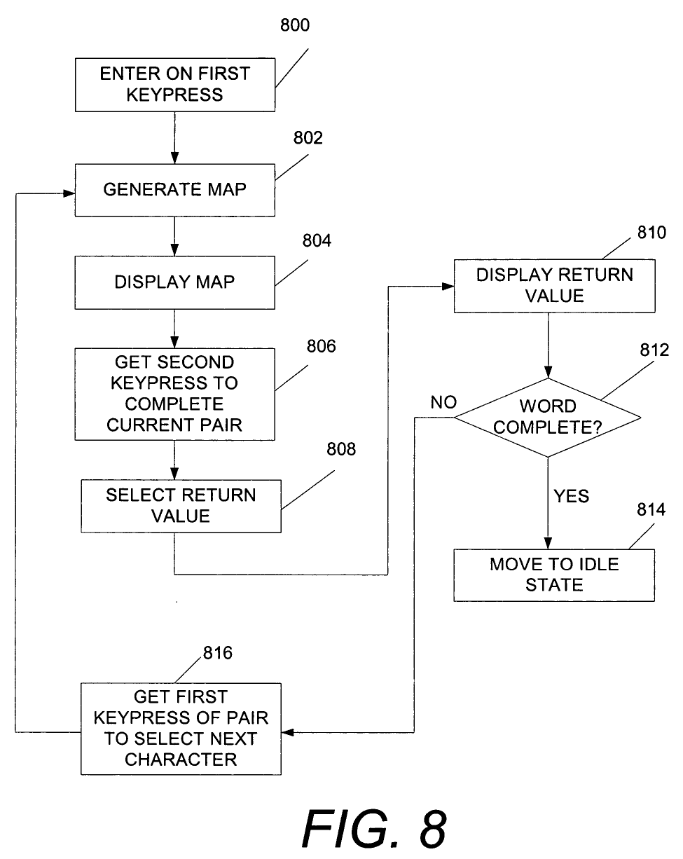

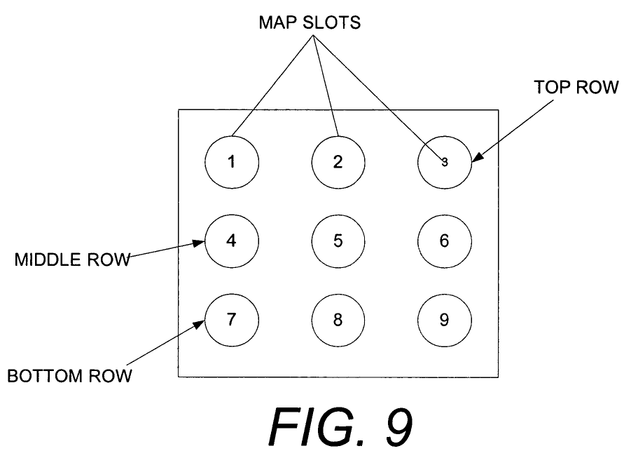

Turning now to FIG. 8 of the drawings, there is shown a flowchart of operations performed by the text entry module 108 while in the word entry state 602, in accordance with one embodiment of the invention. At block 800, upon entry of the first key press the module 108 enters the word entry state 602. The module 108 treats the first key press as the first key press in a pair of key presses that the user will ultimately enter. At block 802, the module 108 generates a map. In one embodiment, the map may have the general structure of the map 900 shown in FIG. 9 of the drawings. Referring to FIG. 9 it will be seen that the map 900 includes a number of “slots” which correspond to the actual keys of the numeric keypad 110. The slots 1, 2, and 3 define a top row, the slots 4, 5, and 6 define a middle row, and the slots 7, 8, and 9 define a bottom row.

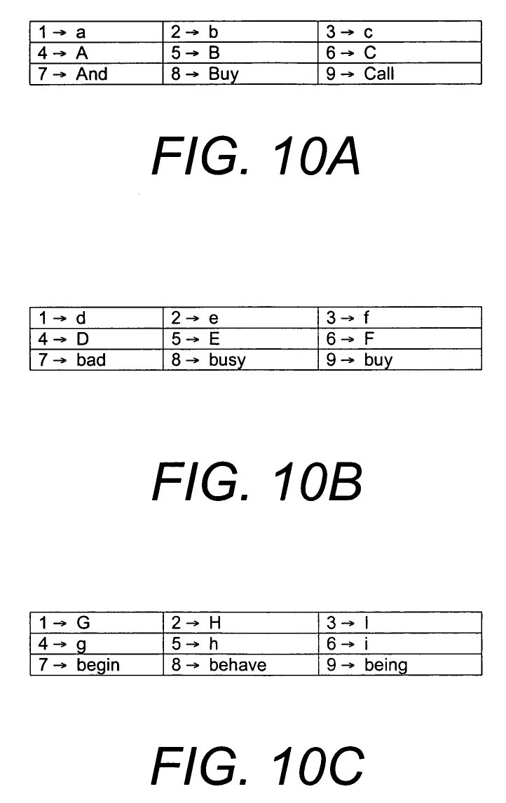

In accordance with one embodiment, generation of the map at block 802 involves operations performed by the components 204, 206, and 208 referred to in FIG. 2 of the drawings. In order to understand the particular operations performed in block 802, reference will be made to FIGS. 10A, 10B, and 10C of the drawings. FIG. 10A shows an example of a map that was generated in accordance with one embodiment of the invention when the first key press corresponds to the numeric key 2. In the map of FIG. 10A, the top row shows the lowercase letters that are mapped to the first, second, and third slots, respectively. The middle row shows the uppercase letters that are mapped to the slots 4, 5, and 6, respectively. The mappings contained in the top and the middle rows are generated based on the mappings shown in FIGS. 4 and 5 of the drawings. In the case of the bottom row of the map of FIG. 10A, the prediction function 204 generates or predicts character strings that a user is likely to input given the first key press and maps these words to the 7, 8, and 9 slots, respectively. The predicted character string may be a word or any character string that has meaning to a user even though it may not be a word. In one embodiment, in order to generate the particular words, the prediction function 204 uses the fact that since the first key press corresponded to the numeric key 2, the only possible words the user is trying to input must begin with the letters “a”, “b”, or “c” in order to search a dictionary of frequently used character strings to identify character strings that begin with the letters “a”, “b”, or “c” that are likely to be input by the user. In one embodiment, given the constraint on the letter with which the word likely to be input must begin, the word prediction function 204 selects values to map to the bottom row based on frequency of use, and in some embodiments, date of last use. In one embodiment, all things being equal, a more frequently used character string that satisfies the constraint on the letter with which the word may begin will be selected to be part of the map in preference to a less frequently used character string. In another embodiment, if two character strings satisfy the constraint on the letter with which the character string may begin, and also have the same frequency of use, then the character string that has a later date of last use will be selected as the likely choice.

It will be appreciated that the mapping of the predicted character strings to the numeric keys in the bottom row is dynamically generated and will change as the user enters more letters in a precise manner, as is described below.

In accordance with one embodiment of the invention, each new letter of a character string that is being precisely input according to the techniques disclosed herein, serves as a further constraint on the prediction function 204 and improves the accuracy of word prediction. In order to appreciate why this is the case, consider the example of a user trying to input the word “Behave”. Initially, through the mechanism of the interface function 200, a set of maps such as that shown in FIGS. 10A, 10B, and 10C of the drawings is displayed to the user. As described above, each of the maps is constructed based on the mappings shown in FIGS. 4 and 5 of the drawings, as well as the prediction function 204. All maps in the set of maps may be displayed simultaneously, or in an alternative embodiment, only a single map may be displayed and the user may shift or cycle through the maps by selecting the shift lock key, which may, in some embodiments be the “*” key. The interface function 200 allows the user to select a map, and in the case of the embodiment that displays many maps simultaneously, highlights the selected map, eg. by bringing the selected map to the foreground of the display, or by redrawing the selected map to a larger scale. In some embodiments, the interface function 200 may provide a visual cue to the user to help the user orientate himself/herself on the map. An example of the visual cue may include highlighting the key that was pressed in order to select the map thereby to provide the user with a sense of where in relation to the map his/her finger is currently positioned. In some cases, the row in the map corresponding to the row of which the key press to select map is a part is also highlighted. Thus, in the case the map of FIG. 10A, the numeric key 2 will be highlighted as the key that was pressed in order to select the map of FIG. 10A, and the top row in the map will be highlighted since the key press to select the map (i.e. numeric key 2) is a part of the top row.

Given the example that the user is trying to input the word “Behave”, the user will select numeric key 2 since the interface function 200 indicates to the user that the letter currently being input (i.e. the letter “b”), occurs within a map can be selected by the numeric key 2. Suppose that in response to selecting the numeric key 2, the map of FIG. 10A is displayed to the user. At this point, it will be appreciated that a different map may be displayed to the user in which the bottom row may change based on other more frequently used words being mapped to the slots in the bottom row. However, the mappings of the top row, and the middle row are static. Since the user is trying to input the word “Behave”, and there is no predicted character string in the map of FIG. 10A that corresponds to the word “behave”, the user will enter either numeric key 2, or numeric key 5, depending on whether a “b” or “B” is required. In this case, the user will enter the numeric key 5. This completes the pair of numeric keys and entry of the character “B” is precise since the apparatus 100 does not have to predict a return character value.

Based on the maps known to the user, or shown to the user via the interface function 200, the user then enters numeric key 3 as the first key in a pair of keys currently being entered to input the next letter in the word “Behave”. In response, the apparatus 100 through the mechanism of the interface function 200 displays the map of FIG. 10B. As will be seen, the map of FIG. 10B has a top row and a middle row which correspond to the mappings of the lowercase and uppercase letters, respectively that can be selected upon completion of a pair of key presses in which the first key press equals numeric key 3. Examining the bottom row in the map of FIG. 10B, it will be seen that the word “bad” is mapped to slot 7, the word “busy” is mapped to slot 8, and the word “buy” is mapped to slot 9. In order to generate the predicted character strings in the bottom row of the map of FIG. 10B, the prediction function 204 is constrained to predict character strings that start with the letter “b” given that the user has already precisely input the letter “b”, using the pair of keys comprising numeric key 2, and numeric key 5, as described above. Thus, in order to generate the mappings of the bottom row in FIG. 10B of the drawings, the prediction function 204 searches through the dictionary in order to find character strings that start with the letter “b” and are frequently used. For example, the current state of the dictionary may be such that the character string “bad” is the currently most frequently used character string starting with letter “b”, the character string “busy” is currently the second most frequently used character string starting with the letter “b”, and the character string “buy” is the currently third frequently used character string starting with the letter “b”.

Unfortunately for the user, given the current state of the dictionary, the word “Behave” is not yet a predicted character string. Since the next letter that the user wishes to enter is the letter “h”, the user enters numeric key 4 in order to select or enter the map associated with the letter 4 since this map is the map that provides the letter “h” as a selectable option. Using the techniques disclosed herein, the map of FIG. 10C was generated so that the top row and bottom row are based on the mappings shown in FIGS. 4 and 5 of the drawings. In generating the bottom row for the map of FIG. 10C, the prediction function 204 was constrained by the fact that the previous two precisely input letters were the letters “B”, and “e”. Thus, in order generate the predicted character strings for the bottom row, the prediction function 204 searches through the dictionary to find the most frequently used character strings that start with the letter “B” and have a second letter equal to the letter “e”. Based on the current state of the dictionary, the prediction function 204 may select the character strings “begin”, “behave”, and “being” as likely return character values. In the present case, the character string “behave” is mapped to the slot 8, and thus selection by the user of numeric key 8 causes the apparatus 100 to set the character string “Behave” as the return character value.

Turning again to FIG. 8 of the drawings, after the map is generated at block 802, at 804, the map is displayed, as described, and at block 806 the apparatus 100 gets or receives the second key press to complete the current pair of key presses being input. This operation has been described with reference to FIGS. 10A, 10B and 10C of the drawings. At block 808, the apparatus 100 selects a return character value, which as already described may be a single character of value such as a letter, a string of character values such as a word, or a predefined character string. As an example, the predefined character string may include a predefined word or a string to show emotions such as the strings “:-)”, or “;-)”. At block 810 the selected return character value is displayed through the mechanism of interface function 200. At block 812, if the current word is complete then the apparatus 100 moves to the idle state 600, at block 814. Various techniques may be used to detect whether the word is complete. In one technique, a word is complete if it matches a word in the dictionary. In another case, a word is complete if the user inputs a special character, for example the “space” character. If the word is not complete, then at block 816, the apparatus gets or receives the first key press of a subsequent pair of key presses to select the next character in the string being input. The operations at block 816 have been described or referenced to FIGS. 10A, 10B, and 10C of the drawings. After execution of block 816, control passes to block 802.

In the case of a user wishing to input a string of numeric characters, upon user input of a dedicated or special “numlock” key, the apparatus 100 moves from the idle state 600 to the numlock state 604. As described, in one embodiment, the dedicated “numlock” key may be the “#” key. In the numlock state 604, further presses of the numeric keys of the keypad 110 are interpreted by the apparatus 100 as numbers in a string of numbers. Thus, for example if a user first presses the numlock key and then presses numeric key 1 followed by numeric key 2 followed by numeric key 3, the apparatus 100 will select a return value of “123”. As can be seen in FIG. 6 of the drawings from the numlock state 604, a further key press of the numlock key moves the system back to the state 600.

One advantage of the techniques disclosed herein, is that the mappings of FIGS. 4 and 5 are such that many of the characters are mapped to a particular two-key combination or pair that requires no lateral movement of a user's finger across the numeric keypad 110 to select the character, or just a simple movement along a straight line between the top, bottom, and middle rows. For example, taking a closer look at the mappings of FIG. 4 and 5, it will be seen that character “d”, “f”, “g”, “k”, “o”, “p”, “u”, “y” require no lateral movement of a user's finger to be input since the first and second keys in the pair of key sequences to select these characters are the same.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure or the scope of the accompanying claims.

What is claimed is:

1. A method of precise text entry using a numeric keypad comprising numeric keys and non-numeric keys, the method comprising:
mapping each of a plurality of pairs of keys to an associated character value, each key in a pair being selected from the group consisting of the numeric keys and the non-numeric keys, wherein the numeric keys range from 0 to 9; and
selecting the character value mapped to a user-input pair of keys as a return character value.

2. The method of claim 1, wherein the keys in each pair are spatially close to at least reduce lateral displacement of a user's finger across the numeric keypad during input.

3. The method of claim 1, further comprising predicting a character string that a user is likely to input by selecting a frequently used character string that has a character spatially located within the character string which corresponds to a possible return character value given a user's key presses to input the character string.

4. The method of claim 3, further comprising, responsive to user-input of a first key in a pair, displaying a map including a set of keys that can be selected to complete the pair and the associated character value mapped to the pair.

5. The method of claim 4, wherein the map comprises return character values selected from the group consisting of an uppercase letter, a lowercase letter, a predicted character string, and a predefined character string.

6. The method of claim 4, wherein the set of keys in the map has a layout corresponding to a layout of the keys of a user's input device.

7. The method of claim 6, further comprising highlighting a row of keys in the map corresponding to a row of keys in the input device of which the first key forms a part.

8. The method of claim 7, further comprising highlighting a key in the map corresponding to the first key in the pair.

9. A computer-readable medium, having stored thereon a sequence of instructions, which when executed by a processor, cause the processor to perform a method of precise text entry using a numeric keypad comprising numeric keys and non-numeric keys, the method comprising:
mapping each of a plurality of pairs of keys to an associated character value, each key in a pair being selected from the group consisting of the numeric keys and the non-numeric keys, wherein the numeric keys range from 0 to 9; and
selecting the character value mapped to a user-input pair of keys as a return character value.

10. The computer-readable medium of claim 9, wherein the keys in each pair are spatially close to at least reduce lateral displacement of a user's finger across the numeric keypad during input.

11. The computer-readable medium of claim 9, wherein the method further comprises predicting a character string that a user is likely to input by selecting a frequently used character string that has a character spatially located within the character string which corresponds to a possible return character value given a user's key presses to input the character string.

12. The computer-readable medium of claim 11, wherein the method further comprises, responsive to user-input of a first key in a pair, displaying a map including a set of keys that can be selected to complete the pair and the associated character value mapped to the pair.

13. The computer-readable medium of claim 12, wherein the map comprises return character values selected from the group consisting of an uppercase letter, a lowercase letter, a predicted character string, and a predefined character string.

14. The computer-readable medium of claim 12, wherein the set of keys in the map has a layout corresponding to a layout of the keys of a user's input device.

15. Apparatus for entering text, precisely, the apparatus comprising:
a numeric keypad;
a mapping function to map each of a plurality of pairs of keys in the numeric keypad to an associated character value, each key in a pair being selected from the group consisting of the numeric keys and the non-numeric keys, wherein the numeric keys range from 0 to 9;
a selection function to select the character value mapped to a user-input pair of as a return character value.

16. The apparatus of claim 15, wherein the keys in each pair are spatially close to at least reduce lateral displacement of a user's finger across the numeric keypad during input.

17. The apparatus of claim 15, further comprising a prediction function to predict a character string that a user is likely to input by selecting a frequently used character string that has a character spatially located within the character string which corresponds to a possible return value given a user's key presses to input the character string.

18. The apparatus of claim 17, further comprising an interface function, which responsive to user-input of a first key in a pair, displays a map including a set of keys that can be selected to complete the pair and the associated character value mapped to the pair.

19. The apparatus of claim 18, wherein the map comprises return character values selecting from the group consisting of a uppercase letter, a lowercase letter, a predicted character string, and a predefined character string.

20. The apparatus of claim 18, wherein the set of keys in the map has a layout corresponding to a layout of the keys of user's input device.
